(19) United States
(12) Patent Application Publication
(10) Pub. No.: US 2026/0255409 A1
(43) Pub. Date: Aug. 27, 2026

(54) EVENT-TRIGGERED RADIO ACCESS TO PRIVATE MOBILE NETWORK FOR DEVICES REGISTERED TO A NEIGHBORING PRIVATE MOBILE NETWORK

(71) Applicant: T-MOBILE INNOVATIONS LLC, Overland Park, KS (US)

(72) Inventors: Bashir A. HASWAREY, Elmhurst, IL (US); Mohammad ABU-SAMRA, Orland Park, IL (US); Narothum SAXENA, Hoffman Estates, IL (US); Michael S. IRIZARRY, Barrington Hills, IL (US)

(21) Appl. No.: 19/065,404

(22) Filed: Feb. 27, 2025

(51) Int. Cl. H04W 76/10; H04L 61/50; H04L 101/654; H04W 84/04

(52) U.S. Cl. CPC H04W 76/10; H04L 61/50; H04L 2101/654; H04W 84/045

(57) ABSTRACT

A method, carried out by a mobile network (MN) core, for conditionally opening access of a provider private MN to a private mobile device affiliated with a neighboring requestor private MN is described. The method includes receiving an access request received by the provider private MN from the private mobile device affiliated with the neighboring requestor private MN. The access request indicates an affiliation with the neighboring requestor private MN for which a pre-configured sharing arrangement exists whereby the provider private MN conditionally provides access to private mobile devices affiliated with the requestor private MN. The method further includes determining that: the access request was submitted by the private mobile device affiliated with the neighboring requestor private MN of the pre-configured sharing arrangement, and current status parameters meet a private MN sharing criteria of the pre-configured sharing arrangement. The method further includes generating an access granted message for causing creating a session for the private mobile device supported by a radio access network (RAN) of the provider private MN.

### FIELD OF THE INVENTION

The present disclosure generally relates to mobile wireless communications. More particularly, the present disclosure is directed to managing limited access to a neighboring private mobile wireless network (e.g., private LTE also referred to as pLTE network) by private mobile wireless network devices registered to a private mobile wireless network.

### BACKGROUND OF THE INVENTION

A variety of private entities maintain their own private mobile wireless networks, including both mobile wireless network core and radio access network components. In such cases, a private entity configures and maintains a self-reliant/complete mobile wireless network including both radio access node (RAN) equipment as well as core network components serving private mobile wireless network devices of an enterprise (e.g., a set of sensors/actuators/controllers configured as IoT devices). The network devices affiliated with the private entity's mobile wireless network are individually assigned unique International Mobile Subscriber Identity (IMSI) identifiers from a range (block) of IMSIs allocated to the private entity mobile wireless network.

The private entities operate in a relatively closed network environment where associated private mobile network wireless devices (including hundreds or even thousands of relatively stationary Internet-of-Things devices) are configured to exhibit a preference to connect to the private entities' private mobile wireless networks. In cases where the strongly-associated private mobile wireless network is rendered inoperative, the associated private mobile wireless network devices generally seek to establish a connection to a next listed mobile wireless network option—such next listed option is typically a public mobile wireless network.

However, having a private mobile wireless device use a public mobile network operator, at times when an associated private mobile wireless network is inoperative, exposes such device to security and reliability issues that can potentially be avoided by instead connecting to another (neighboring) private mobile wireless network within a vicinity of the inoperative private mobile wireless network.

Thus, in the case of an emergency (e.g., a natural disaster) resulting in a private mobile network operator's radio access going down, it is desirable to have highly reliable, secure/trusted and well-defined alternative/backup private mobile wireless network resources available to maintain communications for private mobile wireless network devices of an enterprise (e.g., a set of sensors/actuators/controllers configured as IoT devices). It is also in the interest of a neighboring private mobile wireless network providing such backup service/connectivity, to control/limit such access according to a well-defined shared access agreement and/or criterion.

### SUMMARY OF THE INVENTION

A method, carried out by a mobile network (MN) core, is described for conditionally opening access of a provider private MN to a private mobile device affiliated with a neighboring requestor private MN. The method includes receiving an access request received by the provider private MN from the private mobile device affiliated with the neighboring requestor private MN. The access request indicates an affiliation with the neighboring requestor private MN for which a pre-configured sharing arrangement exists whereby the provider private MN conditionally provides access, via a provider private RAN, to private mobile devices affiliated with the requestor private MN. The method further includes determining, in accordance with receiving the access request, that: the access request was submitted by the private mobile device affiliated with the neighboring requestor private MN of the pre-configured sharing arrangement, and current status parameters meet a private MN sharing criteria of the pre-configured sharing arrangement. The method further includes generating, in accordance with the determining, an access granted message for causing creating a session for the private mobile device supported by a radio access network (RAN) of the provider private MN. The method also includes forwarding, in accordance with the generating, the access granted message to a mobility management entity (MME) component of the provider private MN.

Furthermore, a system is described that comprises a mobile network (MN) core including at least one processor; and a non-transitory computer-readable medium including computer-executable instructions that, when executed by the at least one processor, facilitate carrying out a method for conditionally opening access of a provider private MN to a private mobile device affiliated with a neighboring requestor private MN. The method includes receiving an access request received by the provider private MN from the private mobile device affiliated with the neighboring requestor private MN. The access request indicates an affiliation with the neighboring requestor private MN for which a pre-configured sharing arrangement exists whereby the provider private MN conditionally provides access, via a provider private RAN, to private mobile devices affiliated with the requestor private MN. The method further includes determining, in accordance with receiving the access request, that: the access request was submitted by the private mobile device affiliated with the neighboring requestor private MN of the pre-configured sharing arrangement, and current status parameters meet a private MN sharing criteria of the pre-configured sharing arrangement. The method further includes generating, in accordance with the determining, an access granted message for causing creating a session for the private mobile device supported by a radio access network (RAN) of the provider private MN. The method also includes forwarding, in accordance with the generating, the access granted message to a mobility management entity (MME) component of the provider private MN.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1A is a schematic diagram of an exemplary mobile wireless network radio network environment including a primary MNO and two private mobile wireless networks including a private RAN and core network belonging to distinct enterprises through which respective private network devices of the primary MNO establish an air connection in accordance with the disclosure;

FIG. 1B summarizes fields of an exemplary entry in a structure (e.g. table, spreadsheet, etc.) maintained by the primary MNO to define private MN resource (including RAN access) sharing between geographically proximate MNs;

FIG. 2 is a sequence diagram summarizing messaging flow for executing connection signaling messaging in a case where a private mobile wireless network becomes unavailable to a private mobile wireless device in accordance with an illustrative example of the disclosure; and

FIG. 3 is a flowchart summarizing operation of shared access logic of an extension of the Diameter routing agent in a case where a first private mobile wireless network becomes unavailable to a private mobile wireless device in accordance with an illustrative example of the disclosure.

### DETAILED DESCRIPTION OF THE DRAWINGS

A system, in accordance with the present disclosure, includes a primary MNO hosting (for administrative purposes) private user equipment (UE) devices associated with private mobile wireless networks. Such support may also be carried out via a secondary MNO providing roaming access for the private UE devices on behalf of the primary MNO. The system includes, in accordance with the present disclosure, a neighboring enterprise access management application that is operated as an extension of a Diameter routing agent of the primary MNO that is configured to monitor both an operational status of the private mobile wireless networks and manage limited access by private mobile wireless devices to neighboring private mobile wireless networks in accordance with pre-configured private network resources criteria defining private network resource sharing for private UE devices associated with particular ones of the neighboring private mobile wireless networks.

In the above-summarized operating environment, the neighboring enterprise access management application continuously manages the limited shared access to private mobile wireless network resources. By way of example, after configuring a sharing criteria between neighboring private mobile wireless networks, the neighboring enterprise access management application receives messages indicating various statuses and conditions indicative of a potential need to activate private mobile wireless network sharing between two particular private mobile wireless networks. When such sharing activation criterion is met, the neighboring enterprise access management application activates such shared access in accordance with currently reported statuses of the private mobile wireless networks as well as any of a variety of external conditions (e.g., a natural disaster, an emergency condition (e.g. a fire) at a neighboring enterprise, etc.).

Moreover, once the triggering condition for allowing shared access to private UE devices abates, the neighboring enterprise access management application deactivates previously permitted shared access to private mobile wireless network resources between neighboring private mobile wireless networks.

The above-summarized operation of selective/managed private mobile wireless network access/resource sharing between (geographically proximate) neighboring private mobile wireless networks in accordance with the present disclosure is further described, by way of detailed examples, herein below.

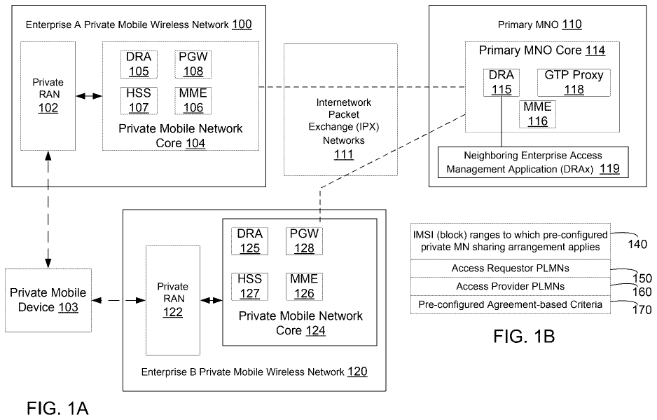

Turning to FIG. 1A, an exemplary environment for carrying out the present disclosure is schematically depicted. An Enterprise A private mobile wireless network (private MN) 100, operating as a roaming mobile wireless data services host, includes a private RAN 102 and a private MN core 104 network. The private RAN 102 is configured to receive a Diameter Protocol connection signaling message from a private mobile device 103 registered as a private UE device affiliated with the Enterprise A private MN 100. The private MN core 104 includes: a Diameter routing agent (DRA) 105, a mobility management entity (MME) 106, a home subscriber server (HSS) 107, and a packet gateway (PGW) 108.

The Enterprise A private MN 100 is configured to communicate through a primary mobile network operator (MNO) 110 (or more generally a network operator (NO) network that may/may not operate an associated RAN) via an internetwork data packet exchange (IPX) of a plurality of IPX networks 111. By way of example, communications associated with devices seeking/having connectivity to the Enterprise A private MN 100 and the primary MNO 110 are carried out according to any established communications protocols, including a protocol under which affiliation with a particular MN operator/service provider entity is determined in accordance with IMSI blocks (ranges of IMSI values) assigned by the primary MNO 110 or provided by (i.e., bring your own IMSI) the Enterprise A MN 100.

The primary MNO 110 includes a primary MNO core 114 that includes: a DRA 115, an MME 116, and a GTP proxy 118. In accordance with the present disclosure, the primary MNO 110 also includes a neighboring enterprise access management application (DRA extension, DRAx) 119 that, in accordance with an illustrative example, operates as an extension of the DRA 115 to manage one or more off-net (i.e. using a RAN other than a RAN of the primary MNO 110).

With continued reference to FIG. 1A, an Enterprise B private mobile wireless network (private MN) 120, configured to communicate through the primary mobile network operator (MNO) 110 that operates as a roaming mobile wireless data services host, includes a private RAN 122 and a private MN core 124 network. The private RAN 122 is configured to receive a Diameter Protocol connection signaling message from the private mobile device 103 registered as a private UE device affiliated with the Enterprise A private MN 100. The private MN core 124 includes: a Diameter routing agent (DRA) 125, a mobility management entity (MME) 126, a home subscriber server (HSS) 127, and a packet gateway (PGW) 128.

The Enterprise B private MN 120 is configured to communicate through a primary mobile network operator (MNO) 110 (or more generally a network operator (NO) network that may/may not operate an associated RAN) via an internetwork data packet exchange (IPX) of the plurality of IPX networks 111. By way of example, communications associated with devices seeking/having connectivity to the Enterprise B private MN 120 and the primary MNO 110 are carried out according to any established communications protocols, including a protocol under which affiliation with a particular MN operator/service provider entity is determined in accordance with IMSI blocks (ranges of IMSI values) assigned by the primary MNO 110 or provided by (i.e., bring your own IMSI) the Enterprise B MN 120.

The DRAx 119 application, in accordance with the present disclosure, operates as a manager of conditionally-triggered limited access provided by neighboring private mobile wireless networks to private UE devices of other/proximately located neighboring private MNs. In particular, the DRAx 119 executes the limited access agreements by applying a current set of monitored conditions to pre-configured shared access criteria. Such pre-configured shared access can include any of a variety of conditions and resulting access provided by a private MN to private UE of another/neighboring private MN. By way of a particular (see FIG. 1B) example, a data structure stored for each pre-configured private MN sharing relationship between two identified private MNs includes (for each agreement): IMSI (blocks) Ranges 140, associated PLMNs of the private MN to which access is being provided 150, associated PLMNs of the Private MN providing access 160, and associated sharing criteria 170. The criteria (applied render an access request decision by the DRAx 119 include, by way of example, service level limits, service impacting conditions (weather, natural disaster, current network load on the service providing private MN, etc.), etc.

The types of agreements entered, and conditions for providing such access are virtually limitless. For example, such sharing could be simply triggered any time the DRAx 119 is informed that a particular private MN is indicated as being inoperative. In other cases, mutual sharing between two neighboring private MNs may be triggered when a severe weather alert issues-even if the neighboring private MNs are still operational. In yet other cases, such sharing may be triggered by a sudden spike in network demand experienced by a private MN needing access to the shared private MN resources of a neighboring private MN. In yet another illustrative example, a trained artificial intelligence/machine learning-based decision logic is carried out by the DRAx 119 based upon previous instances where shared access was determined to be needed/beneficial for any of a wide variety of conditions/parameter values. Such machine learning may involve both actual and predicted weather conditions.

Thus, in summary of the above, the DRAx 119 application utilizes both: a set of pre-configured criteria established between neighboring private MNs and a set of input statuses/conditions parameter values. Based on the input values, the DRAx 119 sets a resulting private MN sharing parameter indicating whether a particular private MN will provide access to MN resources for private UE devices registered to a particular neighboring private MN (identified by, for example an IMSI range). Moreover, the access to the private devices of the requesting neighbor may be based on the type of private UE device (e.g., a critically needed operation sensor device, a safety shutdown signal source, etc.).

With continued reference to FIG. 1A, it is noted that simplified depictions are provided of the primary MNO 110, the Enterprise A private MN 100, and the Enterprise A private MN 120 to emphasize enhanced aspects of the primary MNO 110 relating to the DRAx 119 application operating as a manager of limited access provided by neighboring private mobile wireless networks to neighboring private UE devices in accordance with a pre-configured shared access criteria to which a current set of monitored conditions are applied. Notably, while a single private UE device is depicted in FIG. 1A, hundreds or even thousands of such devices are present in private MN implementations.

Having described an illustrative example where the DRAx 119 functionality is carried out in the primary MNO 110 as an extension of the DRA 115, the functionality of the DRAx 119 is alternatively carried out in a “distributed” arrangement. By way of example, functionality of the DRAx 119 is implemented as an extension of the DRA 105 or the DRA 125. In such case, the DRA 115 (or more particularly an extension thereof) may operate as a centralized manager with respect to reporting parameter statuses (e.g., Enterprise A Private MN 100 is inoperative—i.e., needs access to Enterprise B Private MN 120) as well as a clearing house/manager of pre-configured criteria for sharing private network resources that are ultimately distributed and executed by the various private MNs.

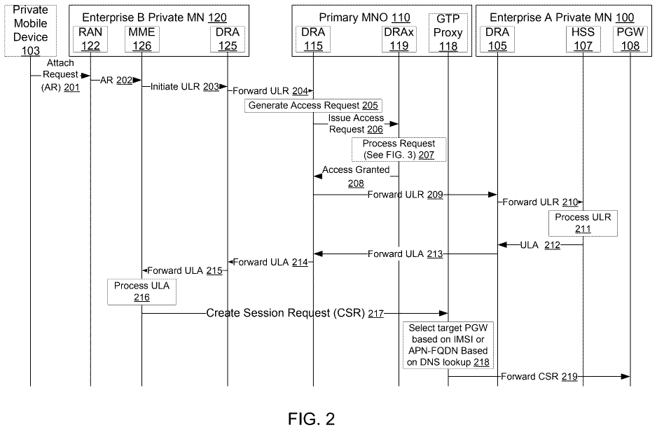

Turning to FIG. 2, a sequence diagram summarizes a message flow for handling an off-network request, originating from the private mobile device 103 (having an IMSI in a range of IMSIs assigned to the Enterprise A private MN 100), to establish a condition-triggered connection to the Enterprise B private MN 120 (a geographically proximate neighbor to the Enterprise A private MN 100). Such request is initiated by the private mobile device 103 in response to a failed attempt to connect to the Enterprise A private MN 100.

With continued reference to FIG. 2, during 201 the private mobile device 103 issues an Attach Request (AR) message that is received by the RAN 122 (e.g. eNB) of the Enterprise B private MN 120. The AR message issued by the private mobile device 103 specifies an IMSI within a range of IMSI values allocated to mobile devices associated with the Enterprise A Private MN 100. The attach request is used to establish mobile wireless service connectivity for the private mobile device 103, via the primary MNO 110.

During 202, the RAN 122 forwards the attach request (via messaging) to the MME 126. During 203 the MME 116 processes the received attach request and initiates/sends an associated Update Location Request (ULR) message to the DRA 125 (ultimately destined for the HSS 107 of the Enterprise A private MN 100).

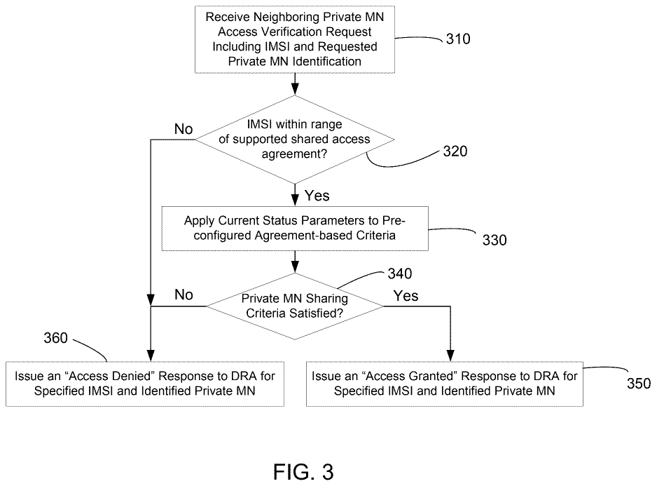

In accordance with standard ULR message handling, during 204 the DRA 125 forwards, without modification, the ULR message to the DRA 115 of the primary MNO 110. During 205 the DRA 115 generates an access request including the received ULR and an identification of the Enterprise B private MN 120 to which the private mobile device 103 seeks to connect/access. During 206 the DRA 115 submits the access request to the DRAx 119 for processing during an access request processing operation 207 (a detailed example of which is provided in FIG. 3). While not shown in FIG. 2, if validation of the access request fails, the DRAx 119 returns an “access denied” response to the DRA 115 that is passed back, via the Enterprise B private MN 120, to the private mobile device 103. However, assuming that the access request is successfully processed (i.e., the request for access to the Enterprise B private MN 120 by the private mobile device 103 affiliated with the Enterprise A private MN 100 is deemed valid by the DRAx 119) during 207, the DRAx 119 issues an “access granted” response during 208.

Thereafter, during 209 the DRA 115 forwards the ULR message to DRA 105 of the Enterprise A private MN 100. During 210, the DRA 105, in turn forwards the ULR message (validated by the DRAx 119) to the HSS 107 of the Enterprise A private MN 100. During 211, the HSS 107 of the Enterprise A private MN 100 processes the received ULR and determines that the ULR message is valid. In accordance with such determination, the HSS 107 issues an Update Location Answer (ULA) message to the DRA 105 of the Enterprise A private MN 100. The DRA 105, during 213, forwards the ULA message to the DRA 115 of the primary MNO 110 for further processing in accordance with the present disclosure.

With continued reference to FIG. 2, during 214, the DRA 115 forwards the ULA message to the DRA 125 of the Enterprise B private MN 120. The DRA 125 forwards the ULA to the MME 126 for processing.

During 216, the MME 126 processes the ULA, and thereafter (during 217) issues a corresponding create session request (CSR), which includes the IMSI of the private mobile device 103, to the GTP proxy 118 of the primary MNO 110 that is configured with the mapping of IMSI blocks to PGWs.

During 218, the GTP proxy 118 identifies the PGW 108 corresponding to the IMSI assigned to the private mobile device 103. Thereafter, during 219, the GTP proxy 118 forwards the CSR (received from the MME 126) to the PGW 108. Alternatively, the PGW may be determined from an access point name-fully qualified domain name (APN-FQDN) using a domain naming service lookup operation.

Turning to FIG. 3, a flowchart summarizes operation of the DRAx 119 to validate (i.e., grant) access by the private mobile device 103 (affiliated with the neighboring Enterprise A private MN 100 by virtue of having an IMSI within a block of IMSIs assigned to Enterprise A) to wireless network resources of the Enterprise B private MN 120 by virtue of a pre-configured criteria allowing such access upon establishing the presence of particular conditions (e.g., the Enterprise A private MN 100 has been rendered inoperative resulting in an emergency status for private devices affiliated with Enterprise A). During 310, the DRAx 119 receives a neighboring MN device access verification request from the DRA 115. The request includes, by way of example, both: (1) an IMSI value assigned the requesting private mobile device (e.g., private mobile device 103), and (2) an identification of a private MN to which access is requested (e.g., Enterprise B Private MN 120).

Thereafter, at 320, if the IMSI is within a range of for a shared access agreement for the target private MN (e.g., Enterprise B private MN 120) that received the initial request from the requesting private mobile device (e.g., private mobile device 103 affiliated with the neighboring Enterprise A private MN 100), then control passes to 330. At 330 the DRAx 119 applies current status parameter values (e.g., a weather warning, network statuses, etc.) to a pre-configured agreement-based criteria corresponding to the identified source private MN of the requesting neighboring private mobile device and the target private MN that received the request. In accordance with the present disclosure, the DRAx 119 receives updates from a variety of sources to facilitate carrying out operation 330. Thereafter, at 340, if the pre-configured conditions tested during 330 are met to grant access to the target private MN by the requesting private mobile device, then control passes to 350. At 350, the DRAx 119 issues an “access granted” response to the DRA 115 in response to the access request received during 310.

On the other hand, if the IMSI is determined to not be within a range of any supported shared access agreement, then control passes from 320 to an alternative operation 360 where the DRAx 119 issues an “access denied” response to the DRA 115 in response to the access request received during 310.

Additionally, if the private MN sharing criteria is not met during 340, control also passes to the “access denied” alternative operation 360.

All references, including publications, patent applications, and patents, cited herein are hereby incorporated by reference to the same extent as if each reference was individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method, carried out by a mobile network (MN) core, for conditionally opening access of a provider private MN to a private mobile device affiliated with a neighboring requestor private MN, the method comprising:
receiving an access request received by the provider private MN from the private mobile device affiliated with the neighboring requestor private MN, wherein the access request indicates an affiliation with the neighboring requestor private MN for which a pre-configured sharing arrangement exists whereby the provider private MN conditionally provides access, via a provider private RAN, to private mobile devices affiliated with the requestor private MN;
determining, in accordance with receiving the access request, that:
the access request was submitted by the private mobile device affiliated with the neighboring requestor private MN of the pre-configured sharing arrangement, and
current status parameters meet a private MN sharing criteria of the pre-configured sharing arrangement;
generating, in accordance with the determining, an access granted message for causing creating a session for the private mobile device supported by a radio access network (RAN) of the provider private MN; and
forwarding, in accordance with the generating, the access granted message to a mobility management entity (MME) component of the provider private MN.

2. The method of claim 1, wherein the method is carried out, at least in part, by an extension of a Diameter routing agent (DRA).

3. The method of claim 2, wherein the method is carried out, at least in part, in a primary MN core.

4. The method of claim 3, wherein an agreement structure defining the terms of the pre-configured private MN resource sharing arrangement is maintained by the primary MN core, and
wherein the determining comprises applying the agreement structure to a set of current status conditions impacting the neighboring requestor private MN, 5. The method of claim 4, wherein the agreement structure includes a set of International Mobile Subscriber Identity (IMSI) identifiers allocated to the requestor private MN.

6. The method of claim 4, wherein the agreement structure includes a list of PLMNs associated with the requestor private MN.

7. The method of claim 4, wherein the agreement structure includes a list of PLMNs associated with the provider private MN.

8. The method of claim 4, wherein the agreement structure includes a pre-configured access criteria.

9. The method of claim 1, wherein the determining is carried out, at least in part, by an MN core of the provider private MN.

10. The method of claim 1, wherein the determining is carried out, at least in part, by a primary MN core.

11. A system comprising a mobile network (MN) core, wherein the MN core comprises:
at least one processor; and
a non-transitory computer-readable medium including computer-executable instructions that, when executed by the at least one processor, facilitate carrying out a method for conditionally opening access of a provider private MN to a private mobile device affiliated with a neighboring requestor private MN, wherein the method comprises:
receiving an access request received by the provider private MN from the private mobile device affiliated with the neighboring requestor private MN, wherein the access request indicates an affiliation with the neighboring requestor private MN for which a pre-configured sharing arrangement exists whereby the provider private MN conditionally provides access, via a provider private RAN, to private mobile devices affiliated with the requestor private MN;
determining, in accordance with receiving the access request, that:
the access request was submitted by the private mobile device affiliated with the neighboring requestor private MN of the pre-configured sharing arrangement, and
current status parameters meet a private MN sharing criteria of the pre-configured sharing arrangement;
generating, in accordance with the determining, an access granted message for causing creating a session for the private mobile device supported by a radio access network (RAN) of the provider private MN; and
forwarding, in accordance with the generating, the access granted message to a mobility management entity (MME) component of the provider private MN.

12. The system of claim 11, wherein the method is carried out, at least in part, by an extension of a Diameter routing agent (DRA).

13. The system of claim 12, wherein MN core is a primary MN core.

14. The system of claim 13, wherein an agreement structure defining the terms of the pre-configured private MN resource sharing arrangement is maintained by the primary MN core, and
wherein the determining comprises applying the agreement structure to a set of current status conditions impacting the neighboring requestor private MN.

15. The system of claim 14, wherein the agreement structure includes a set of International Mobile Subscriber Identity (IMSI) identifiers allocated to the requestor private MN.

16. The system of claim 14, wherein the agreement structure includes a list of PLMNs associated with the requestor private MN.

17. The system of claim 14, wherein the agreement structure includes a list of PLMNs associated with the provider private MN.

18. The system of claim 14, wherein the agreement structure includes a pre-configured access criteria.

19. The system of claim 11, wherein the determining is carried out, at least in part, by an MN core of the provider private MN.

20. The system of claim 11, wherein the determining is carried out, at least in part, by a primary MN core.
